(19) United States
(12) Patent Application Publication
(10) Pub. No.: US 2024/0425697 A1
(43) Pub. Date: Dec. 26, 2024

(54) COMPOSITION OF (CO) POLYESTERS, SINGLE-LAYER FILM AND USE FOR PACKAGING BAG

(71) Applicant: LA BOULANGERE, LES ESSARTS EN BOCAGE (FR)

(72) Inventors: Anaïs LAJARRIGE, Gestel (FR); Lucie JUILLAN, Bellevigny (FR)

(73) Assignee: LA BOULANGERE, LES ESSARTS EN BOCAGE (FR)

(21) Appl. No.: 18/746,636

(22) Filed: Jun. 18, 2024

(30) Foreign Application Priority Data
Jun. 21, 2023 (FR) 2306403

(51) Int. Cl. C08L 67/02; B29B 7/48; B29C 48/00; B29C 48/08; B29K 67/00; B29K 105/16; B65D 85/36; C08J 5/18; C08K 5/20

(52) U.S. Cl. CPC C08L 67/02; B65D 85/36; C08J 5/18; C08K 5/20; B29B 7/48; B29C 48/0018; B29C 48/08; B29K 2067/00; B29K 2105/16; B29K 2995/006; C08J 2367/02; C08J 2431/04; C08J 2467/02; C08J 2467/04; C08L 2203/16; C08L 2205/025; C08L 2205/035

(57) ABSTRACT

A composition including from 68% to 75% by weight of at least one rigid (co)polyester selected from the group formed by polybutylene succinate, polylactide, polyhydroxyalkanoate; from 25 to 35% by weight of at least one flexible (co)polyester selected from the group formed by polybutyrate, poly(ε-caprolactone) and PBS copolymers; from 0.2 to 5% by weight of at least one hydrophobic additive selected from the group formed by behenamide, erucamide, stearamide and oleamide; method for preparing a single-layer film from this composition by extrusion blowing; single-layer film obtained and packaging articles for bakery products including the single-layer film.

### FIELD

The present invention pertains to the field of supple packaging, suitable for food contact. It relates more particularly to compositions of biodegradable and advantageously compostable polymers, usable for the manufacture of single-layer supple films having particularly low water vapor permeability and usable for food packaging.

### BACKGROUND

Global plastics production is steadily increasing and reached 390 million tons in 2021, consuming nearly 10% of global oil production. In Europe, more than 57 million tons were produced in 2021 (Plastics Europe, 2022, notably https://plasticseurope.org/wp-content/uploads/2023/03/PE-PLASTICS-THE-FACTS_FINAL_DIGITAL-1.pdf).

Low- and high-density polyethylenes, LDPE/LLDPE and HDPE respectively, as well as polypropylene, are the most commonly used plastics, representing 14.7%, 9.3% and 16.6% of all plastics respectively.

The packaging sector is the largest consumer of these plastics with more than 40% of demand in 2021. Their great success is due to their extreme versatility. In the field of food packaging, they are indispensable for protecting foodstuffs and ensuring their preservation and their nutrient and taste qualities until consumption. However, due to their long lifetime, their impact on the environment is considerable.

Collection and processing channels for these plastic materials have been set up to limit environmental pollution, but these channels remain partial. Indeed, plastic waste escapes from collection and ends up in the environment. For example, the amount of plastic waste in the oceans was estimated at 150 million metric tons in 2015 and is expected to reach 600 million metric tons by 2040 if nothing changes (National Geographic, 2020, notably https://www.nationalgeographic.fr/environment/2020/08/la-quantite-de-plastique-dans-les-oceans-devrait-tripler-dici-2040).

Regarding processing channels, they change from year to year. In 2020, 29.5 million tons of post-consumer plastic waste were collected in Europe. More than a third (35%) was recycled, 42% was incinerated and 23% was landfilled (Plastics Europe, 2022).

More specifically, recycling of plastic packaging in France amounted to around 30% in 2021 (CITEO, notably https://www.CITEO.com/le-mag/les-chiffres-du-recyclage-en-france). This figure is relatively low, and the future of the various containers is very contrasting: 59% for bottles and vials and only 11% for other plastic packaging. Indeed, recycling channels are evolving, but not all plastics are currently recycled. Only PET and HDPE have established recycling channels.

For supple plastic packaging, recycling is more complicated. In 2018, 310,000 tons were put on the market, 13% in polypropylene (PP), 39% in polyethylene (PE) and 48% in other plastics (complexes, etc.) (CITEO, notably https://bo.CITEO.com/sites/default/files/2020-11/20201124_brochure_R %26D_Citeo_pap_finale.pdf). Only supple PE packaging can currently be recycled or rather transformed into granules that will able to be used to manufacture other plastic products such as hoses or bags for waste storage.

In this context, it appears essential to find alternatives to these conventional plastics.

For several years, innovations have been emerging, notably in the field of biobased and biodegradable plastics. These materials are already used for the manufacture of various products, notably plastic bags. Examples of these polymers are polylactic acid (PLA), polybutylene succinate (PBS) and derivatives thereof or polyhydroxyalkanoates (PHA).

These alternative materials available on the market have specific properties with advantages and disadvantages for each application: too supple or too rigid, poor thermal stability, insufficient barrier properties, etc. This is mainly the reason why they are rarely used in food packaging.

However, there remains a need to have supple packaging available that can be used in the food sector and which has sufficient barrier properties, notably low water vapor permeability. In the context presented above, there remains also a need to have available such packaging that is at least partially biobased, and also biodegradable, preferably compostable.

There are already patent applications that describe sheets of biodegradable polymers, multilayers, i.e. formed of several layers composed of different polymer(s). The combination of these different polymer layers makes it possible to benefit from the advantages of each of them. By way of example, mention may be made of patent application WO2020/222232 which targets a multilayer sheet formed of first and second outer layers of polymers comprising PBS or PBSA and an inner layer comprising from 70 to 80% by weight of PLA and from 20 to 30% by weight of PCL, this type of sheet has good physical resistance and also at high temperatures. These sheets are mainly used to manufacture containers to hold liquids.

One solution to improve the barrier properties, proposed notably in EP 2,790,920, has been to add elements such as nano-clays to the composition of polymers, however, the use of nanoparticles is currently controversial, particularly in the foodstuffs field. In addition, it is very difficult to recycle articles incorporating nanoparticles as fillers, in general the potential migration of these nanoparticles raises questions.

There is still a need to have available polymer compositions making it possible to obtain films for packaging having low water vapor permeability and easy to implement using conventional plastics manufacturing tools.

Thus, the inventors have directed their research towards compositions of polymers making it possible to obtain single-layer films.

Single-layer sheets based on mixtures of (co)polyesters, impermeable to gasses are also described notably in EP 2,998,342 A2, these sheets mainly comprise rigid polymers: they are typically formed of 80% by weight of PBS and 20% by weight of PLA. These sheets do not have the mechanical properties sought for the single-layer films according to the invention, notably in terms of folding capacity or rigidity since the sheet of composition 80% by weight of PBS and 20% by weight of PLA has a Young's modulus equal to 569 MPa.

### SUMMARY

Surprisingly and advantageously, the inventors have developed a particular composition of (co)polyesters having mechanical properties suitable for the formation of single-layer films usable for food packaging, these films having in particular improved barrier properties notably in terms of water vapor permeability.

A first object of the present invention pertains to a composition comprising:
from 68% to 75%, preferably from 69% to 75% by weight of at least one rigid (co)polyester selected from the group formed by polybutylene succinate (PBS), polylactide (PLA), polyhydroxyalkanoate (PHA), relative to the total weight of the composition;
from 25 to 35% by weight of at least one flexible (co)polyester selected from the group formed by polybutylene adipate terephthalate or polybutyrate (PBAT), poly(ε-caprolactone) (PCL) and copolymers of polybutylene succinate (PBS), relative to the total weight of the composition;
from 0.2 to 5%, and preferably from 0.5 to 2% by weight of at least one hydrophobic additive selected from the group formed by behenamide, erucamide, stearamide and oleamide, relative to the total weight of the composition.

A first advantage of these compositions is their ecological impact. The compositions according to the invention prepared from biodegradable polymers make it possible to obtain biodegradable and preferably compostable and/or recyclable articles having significantly less impact on the environment than articles prepared from petrochemical and non-biodegradable plastics.

Indeed, the compositions according to the invention may be made from (co)polyesters derived from renewable resources, in this case, the composition is called “biobased”.

“Biobased” or “biosourced” means plastics manufactured from plant-based resources such as corn, cassava, potato, wood, cotton, seaweed, sugar cane, beet, the biobased character is defined by the ASTM D6866-22 standard.

Advantageously, the compositions according to the present invention are prepared from (co)polyesters of which at least 50% by weight are biobased as defined in the ASTM D6866-22 standard.

The compositions according to the present invention are distinguished by their homogeneity advantageously allowing the preparation of stable and homogeneous single-layer films suitable for use in the manufacture of supple packaging for food. In particular, these films have improved barrier properties notably in terms of water vapor permeability, they also have a very satisfactory oxygen permeability for the intended uses.

These compositions of biodegradable (co)polyesters have both a good ability to be implemented by extrusion blowing on an industrial scale while retaining satisfactory physical, mechanical properties.

In particular, the compositions according to the present invention have good sealability properties enabling the single-layer film to be industrially shaped in the form of bags.

Thus, a second object of the present invention relates to a method for preparing the single-layer film from the composition according to the invention comprising a step of extrusion blowing.

A third object of the invention pertains to a single-layer film comprising, preferably consisting of, the composition according to the invention, or prepared according to the preparation method according to the invention, preferably, the single-layer film has a thickness ranging from 35·10⁻⁶ m to 40·10⁻⁶ m.

A fourth object of the invention pertains to an article comprising, preferably consisting of, the monolayer film according to the present invention. Advantageously, the article according to the present invention is a so-called “wicket bag”, preferably intended for packaging bakery products, in particular sandwich bread. A wicket bag is a bag held on a wire support, or a “wicket”.

The article is advantageously biodegradable and compostable.

“Biodegradable” or “biodegradability” means the property of a material to degrade under biological activity, for example under the action of enzymes and/or micro-organisms, by a reduction of its molar mass, in particular the decomposition of an organic chemical compound into carbon dioxide, water and mineral salts, the other elements present (mineralization) and the appearance of a new biomass, under the action of micro-organisms in the presence of oxygen; or decomposition into carbon dioxide, methane, mineral salts and creation of a new biomass, in the absence of oxygen, it is defined by the European Standard EN 13432:2000, as well as its French extension: NF 14995.

“Recyclable” means the recovery of all or part of the constituents of a material at the end of its life or of a material from manufacturing residues in order to reintroduce them into the production cycle of the same or another material.

“Compostable” or “compostability” means a process which consists in placing fermentable products under conditions (temperature, humidity, oxygenation, presence of soil micro-organisms, etc.) allowing their biodegradation. To be considered compostable within the meaning of the EN 13432: 2000 standard, the material must be biodegraded to at least 90% after 6 months in an industrial composting environment; at least 90% of the residues must have a size of less than 2 mm after 3 months of composting; and the absence of ecotoxic effects must be demonstrated as well as the agricultural quality of the compost obtained.

Advantageously, the articles according to the present invention are compostable after use under industrial composting conditions in accordance with the EN 13432: 2000 standard and in domestic composting conditions in accordance with the NF T 51-800: 2015 standard.

Other aspects, advantages and properties of the present invention are presented in the following description and examples.

### DETAILED DESCRIPTION

### Composition

The composition according to the present invention comprises a mixture of at least two, preferably three biodegradable (co)polyesters.

The composition according to the present invention comprises from 68% to 75%, preferably from 69% to 75% by weight of at least one rigid (co)polyester selected from the group formed by PBS, PLA, PHA relative to the total weight of said composition.

Preferably, the composition according to the present invention comprises, as rigid (co)polyesters, PLA and at least one other rigid polyester selected from PBS and PHA.

Still preferably, it comprises, as rigid (co)polyesters, from 63% to 72% by weight of at least one polyester selected from the group formed by PBS and PHA relative to the total weight of the composition and from 3% to 7%, preferably from 4% to 6% by weight of PLA relative to the total weight of the composition.

“Rigid (co)polyester” for the purposes of the present invention means a polymer having the following characteristics: a stiffness modulus greater than 450 MPa, preferably greater than 500 MPa and less than 3600 MPa and an elongation at break greater than 2% and less than 400%, preferably less than 350%

The composition according to the present invention also comprises from 25% to 35% by weight of at least one flexible (co)polyester selected from the group formed by PBAT, PCL, and copolymers of PBS preferably poly(butylene succinate adipate) (PBSA), relative to the total weight of said composition. Preferably, the composition comprises from 25% to 30% by weight of PBSA, relative to the total weight of said composition.

“Flexible (co)polyester”, or supple within the meaning of the present invention, means a polymer having the following characteristics: a stiffness modulus greater than 40 MPa and less than 500 MPa, preferably less than 350 MPa and an elongation at break greater than 300%, preferably greater than 400% and less than 700%.

The composition also comprises from 0.2 to 5%, and preferably from 0.5 to 2% by weight of at least one hydrophobic additive selected from the group formed by behenamide, erucamide, stearamide and oleamide, relative to the total weight of the composition. Preferably, the hydrophobic additive is behenamide.

The composition also comprises, by weight relative to the total weight of the composition, from 0 to 5%, and preferably from 0.5 to 2% by weight of at least one vinyl polymer selected from the group formed from grafted or non-grafted polyvinyl acetate and non-grafted polyethylene vinyl acetate (ethylene-vinyl acetate copolymers), called PVAc, or grafted polyethylene vinyl acetate. Preferably, the vinyl polymer is polyvinyl acetate (PVAc).

“Grafted vinyl polymer” means that the vinyl polymer is modified by grafting, preferably with at least one agent selected from the group consisting of maleic anhydride, glycidyl methacrylate, hydroxyethyl acrylate, methyl methacrylate, butyl acrylate, acrylic acid, preferably maleic anhydride and glycidyl methacrylate.

The composition also comprises from 0 to 10%, preferably from 0 to 5% of at least one additive chosen from plasticizers, slip agents, implementation agents (process aids), anti-blocking agents.

Thus, the compositions according to the present invention advantageously have a Young's modulus ranging from 200 to 420 MPa, preferably from 200 to 300 MPa.

The compositions according to the present invention advantageously have a stress at yield ranging from 12 MPa to 30 MPa.

The compositions according to the present invention advantageously have an elongation at yield ranging from 14% to 50%.

The compositions according to the present invention advantageously have an elongation at break ranging from 400% to 700%.

The Young's modulus, also known as stiffness modulus or elasticity modulus, is determined in accordance with the NF EN ISO 527-1 standard of 2012 Apr. 1.

The stress at yield, the elongation at yield and the elongation at break are also determined in accordance with the NF EN ISO 527-1 standard of 2012 Apr. 1.

The composition according to the invention is suitable for use for forming a single-layer film.

“Single-layer film” means a film formed of a single layer of homogeneous (co)polyesters. Advantageously, the single layer film has a thickness ranging from 35·10⁻⁶ m to 40·10⁻⁶ m (35 to 40 microns)

Thus, the inventors have shown that the compositions according to the invention have mechanical properties allowing the formation of a single-layer film sufficiently supple and resistant to be used for the manufacture of so-called “wicket” packaging bags.

Further, the composition according to the invention has good usability (processability) on an industrial scale while retaining satisfactory physical and mechanical properties. The composition is suitable for use with automated packaging machines for the formation of supple bags for packaging.

In addition, the films according to the present invention have a particularly low water vapor permeability. The water vapor permeability of the films according to the present invention ranges from 70 to 180 in g/(m²·day), preferably less than 160 in g/(m²·day) and even more preferably less than 110 in g/(m²·day) determined in accordance with the ASTM E96-22 standard, on films of 35·10⁻⁶ m thickness.

The water vapor permeability is determined according to the ASTM E96-22 standard, the methodology and measurement conditions related to this standard are detailed in Example 2 below.

Oxygen permeability (P 02) is determined according to the ASTM F1927: 2020 standard on films with a thickness of 35·10⁻⁶ m.

The compositions according to the invention may also comprise additives able to improve the esthetics notably the gloss and/or the slip or even reduce the opacity of the single-layer films.

The single-layer films according to the present invention are stable for several months: their physical properties are not degraded.

The articles according to the present invention are perfectly suitable for automatic packaging of bread-making, bakery and cake-making products, in particular sandwich bread, pastries, brioche bread, chocolate rolls, croissants and brioches.

### Method for Preparing a Single-Layer Film

The single-layer film according to the present invention may be obtained by a method chosen from “cast” extrusion methods also called flat die, bubble extrusion, also called extrusion blowing, or tubular extrusion.

Preferably, the single-layer film according to the invention is obtained by an extrusion blowing method.

Extrusion blowing is a process in plastics manufacturing that consists in shaping plastic films or sheaths. A thin sheath is extruded vertically through an annular die. This sheath, momentarily pinched, is inflated by an air flow which is introduced via the axis of the die head. Under the action of stretching and inflation, a bubble is formed. Air cooling allows solidification of the sheath which is then flattened by two panels converging towards draw rolls. The rotational speed of these rollers makes it possible to adjust the sheath thickness. The diameter of the sheath is, for its part, controlled by the air volume in the sheath.

This process, followed by a forming comprising cutting and then sealing steps, makes it possible to obtain an article in the form of a bag, in particular a plastic wicket bag, in an automated, simple, practical and economical manner.

Further, the composition according to the present invention makes it possible to obtain printable plastic wicket bags. The film printing step usually takes place before cutting and shaping. Of course, it is the skill of the person skilled in the art to select the ink with the best printing properties according to the desired visual result.

While ensuring optimal storage and keeping the softness of the pastries intact, this wicket bag procures great flexibility and can be offered in several aspects, with or without closures, in various shapes, materials and colors.

The following examples are intended to illustrate the invention without limiting its scope.

### EXAMPLES

### Example 1—Compositions

Table 1 shows the compositions in accordance with the invention. The proportions of the different components are expressed as a percentage by weight relative to the weight of the final composition.

The PBS used is marketed under the name FZ91 by PTT MCC Biochem Company Ltd.

The PBSA used is marketed under the name FD92 by PTT MCC Biochem Company Ltd.

The PLA used is marketed under the name LX975 by TotalEnergy Corbion.

The PVAc used is a product in the form of microbeads marketed under the name Vinnex by WACKER.

TABLE 1
Compositions in accordance with the invention

| | F1 | F2 | F3 | F4 | F5 |
|---|---|---|---|---|---|
| % PBS (rigid) | 69.3 | 64.5 | 64.3 | 64.0 | 63.7 |
| % PBSA (flexible) | 29.7 | 28.3 | 28.2 | 28.1 | 27.9 |
| % PLA (rigid) | 0.0 | 4.9 | 4.9 | 4.8 | 4.8 |
| % Hydrophobic | 1.0 | 1.0 | 1.0 | 1.0 | 1.0 |
| additive (1) | | | | | |
| PVAc | 0.0 | 1.0 | 1.0 | 1.0 | 1.0 |
| Slip agent (2) | 0.0 | 0.2 | 0.4 | 0.7 | 1.0 |
| Anti-blocking agent: | 0.0 | 0.1 | 0.2 | 0.4 | 0.6 |
| talc | | | | | |
| Sum rigid polyesters | 69.3 | 69.4 | 69.2 | 68.8 | 68.5 |

(1) Crodamide BR marketed by CRODA
(2) Incroslip SL marketed by CRODA.

Comparative compositions are shown in Table 2. The proportions of the different components are expressed as a percentage by weight relative to the weight of the final composition.

TABLE 2
Comparative compositions

| | C1 | C2 |
|---|---|---|
| PBS (rigid) | 70 | 62.0 |
| PBSA (flexible) | 30 | 27.2 |
| PLA (rigid) | 0.0 | 4.7 |
| Hydrophobic additive (1) | 0.0 | 0.9 |
| PVAc | 0.0 | 0.9 |
| Slip agent (2) | 0.0 | 2.8 |
| Anti-blocking agent: talc | 0.0 | 1.5 |
| Sum rigid polyesters | 70 | 66.7 |

### Method for Preparing Compositions

The different components of the compositions are mixed (compounded) by an extrusion process, i.e. the (co)polyesters and additives are mixed using an extruder. The extruder used is a ZSE 27 MAXX/HP twin screw extruder. It is composed of a twin worm screw which rotates inside the cylindrical sleeve regulated in temperature by heating and cooling systems. The twin-screw has a profile making it possible to obtain a homogeneous mixture and good dispersion of the various components of the formulation at the die outlet. The polymers and additives are introduced into the feed hoppers before being sent, in a specific order and zone, into the extruder. The extruder makes it possible to convey the biodegradable (co)polyesters and the additives of said composition, to melt them, put them under pressure and mix them in order to obtain a strand at the die outlet which will then be cooled in a water bath before being granulated and then implemented by extrusion blowing.

The temperatures of the different extruder zones were adjusted in accordance with the phase change temperatures of the biodegradable (co)polyesters and their degradation temperature. The screw speed inside the sleeve was chosen so as to ensure a good mixing of said composition by shear without degrading the material. The parameters used are summarized in the table below.

The biodegradable (co)polyesters are pre-dosed and fed into the main hopper. The additives are pre-dosed and incorporated into a secondary hopper.

Table 3 shows the parameters of the twin-screw extruder for the production of the composition in the form of pellets.

TABLE 3
Twin-screw extruder parameters

| Zone | 1 | 2: | 3: | 4 | 5 | 6 | 7 | 8 | 9 | 10 | 11 | 12 |
|---|---|---|---|---|---|---|---|---|---|---|---|---|
| Temperature (° C.) | 140 | 140 | 145 | 145 | 150 | 150 | 155 | 160 | 160 | 165 | 165 | 170 |

Speed: 45-60 kg/h.

### Extrusion Blowing

The extrusion blowing was carried out with a CMG model 4530/HTM single screw extruder with air cooling, having a centrally fed die with radiating channels and a die diameter of 0.1 m (100 mm).

Table 4 shows the parameters of the extrusion blowing extruder for the production of the single-layer film

TABLE 4
Bubble extruder parameters (extrusion blowing)

| Zone | 1 | 2: | 3: | 4 | 5 | 6 | 7 |
|---|---|---|---|---|---|---|---|
| Temperature (° C.) | 135 | 140 | 150 | 155 | 160 | 165 | 165 |
| Screw speed (rpm) | 20-40 | | | | | | |
| Drawing speed | 7-11 | | | | | | |
| (m/min) | | | | | | | |

| | |
|---|---|
| Outdoor air % | 30-40 |

### Example 2—Single-Film Properties

### Physical Properties

The Young's modulus, stress at yield, elongation at yield and elongation at break values of the compositions were measured in accordance with the protocols of the EN ISO 527-1 standard (2012 Apr. 1).

Thus, it was verified that the compositions according to the invention have:
a Young's modulus ranging from 200 to 420 MPa, preferentially from 200 to 300 MPa;
a stress at yield ranging from 12 MPa to 30 MPa
an elongation at yield ranging from 14% to 50%;
a higher elongation at break ranging from 400% to 700%.

### Water Vapor Permeability

### 1. Preparation of the Samples

The samples of the single-layer films to be tested were placed at 23° C. throughout their storage before analysis. The single-layer films had a thickness of 35·10⁻⁶ m.

### 2. Conditions for Carrying Out the Tests

The tests were carried out under the following conditions:
Location of the cut-out: the test pieces were taken at different locations on the coil, on the external face of the coil:
Surface area of the test pieces: 50 cm²
the analysis of the thickness of the test pieces subjected to the tests was carried out at 5 points of the test pieces.

### 3. Methodology

The analysis is carried out according to a method based on the ASTM E96-22 standard according to the desiccant method (gravimetric method). According to this standard, capsules containing a desiccant (anhydrous silica gel) and sealed by the material, i.e. the single-layer film under test, are placed in a controlled atmosphere. These capsules are weighed at regular intervals. The increase in mass, as soon as it is proportional to the time interval, makes it possible to determine the water vapor transmission coefficient.

Water vapor transmission rates are expressed in g/(m²·day).

### 4. Measurement Conditions

Measurements were carried out under the following conditions: in a climatic chamber, with a 10⁻⁴ g precision balance, using permeability cups.

The set point temperature and humidity values: 38° C. and 90% RH.

The tests were carried out in triplicate, i.e. the number of samples subjected to the tests was 3 per reference.

The water vapor permeability was measured on single-layer films of 35·10⁻⁶ m.

Table 4 summarizes the water vapor permeability values of the single-layer films of 35·10⁻⁶ m obtained from the compliant and comparative compositions presented above.

TABLE 4

| Composition of the films | P H₂O g/(m² · day) |
|---|---|
| F1 | 93 ± 4 |
| F2 | 108 ± 7 |
| F3 | 152 ± 9 |
| F4 | 163 ± 10 |
| F5 | 171 ± 5 |
| C1 | 416 ± 16 |
| C2 | 225 ± 23 |

The single-layer films according to the invention F1-F5 have a significantly lower water vapor permeability than the comparative single-layer films C1 and C2.

### Oxygen Permeability

### 1. Preparation of the Samples

The samples of the single-layer films to be tested were placed at 23° C. throughout their storage before analysis. The single-layer films had a thickness of 35·10⁻⁶ m.

### 2. Conditions for Carrying Out the Tests

The tests were carried out under the following conditions:
Location of the cut-out: the test pieces were taken at different locations on the coil, on the external face of the coil:
Surface area of the test pieces: 50 cm²
the analysis of the thickness of the test pieces subjected to the tests was carried out at 5 points of the test pieces.

### 3. Methodology

The analysis is carried out according to a method based on the ASTM F1927: 2020 standard.

According to this standard, samples are cut and placed in the cells of the permeability measuring apparatus. The inner side of the material is swept with the carrier gas continuously while the outer side is swept with the test gas. Oxygen diffuses through the material and is directed to the detector.

The oxygen transfer coefficient is expressed in cm3/(m²·day·1atm).

### 4. Measurement Conditions

The measurements were carried out under the following conditions:
Apparatus: OXTRAN 2/22 H with coulometric detector;
Carrier gas: N2/5% H2 mixture; Test gas: pure oxygen;
   Set point temperature and humidity values: 23° C. and relative humidity inside 50%—Relative humidity outside 50%. The tests were carried out in duplicate, i.e. the number of samples subjected to the tests was 2 per reference.

The water vapor permeability was measured on single-layer films of 35·10⁻⁶ m.

The compositions according to the present invention have an oxygen permeability coefficient ranging from 410 to 520 cm³/(m²·day·atm). This value range is very satisfactory for the intended application since it is significantly lower than the value obtained with conventional plastic films such as polyethylenes or polypropylenes.

The compositions according to the present invention make it possible to obtain single-layer films having adequate strength and flexibility for the intended uses.

The packaging has a pleasant feel (soft touch).

These films are strong enough to be used for packaging bakery products, they are not easy to tear.

The films obtained are suitable for food contact as defined by Regulation (EU) N^{o} 10/2011 (Commission Regulation (EU) No 10/2011 of Jan. 14, 2011). It has been observed that sandwich bread preserved in a wicket bag made from a composition according to the invention retains its nutritional and organoleptic properties for at least 17 days.

The films obtained have a water vapor permeability of less than 180 in g/(m²·day), preferably less than 160 in g/(m²·day) determined in accordance with the ASTM E96-22 standard, on films of 35·10⁻⁶ m thickness.

1. A composition comprising:
from 68% to 75%, preferably from 69% to 75% by weight of at least one rigid (co)polyester selected from the group formed by polybutylene succinate, polylactide, polyhydroxyalkanoate, relative to the total weight of the composition;
from 25% to 35% by weight of at least one flexible (co)polyester selected from the group formed by polybutylene adipate terephthalate, poly(ε-caprolactone) and copolymers of polybutylene succinate, relative to the total weight of the composition;
from 0.2 to 5% and preferably from 0.5 to 2% by weight of at least one hydrophobic additive selected from the group formed by behenamide, erucamide, stearamide and oleamide, relative to the total weight of the composition.

2. The composition according to claim 1, comprising, as rigid (co)polyesters:
from 63% to 72% by weight of at least one polyester selected from the group formed by polybutylene succinate and polyhydroxyalkanoate relative to the total weight of the composition, and
from 3% to 7%, preferably from 4% to 6% by weight of polylactide relative to the total weight of the composition.

3. The composition according to claim 1, comprising, as flexible polymer:
from 25% to 30% by weight of poly(butylene succinate adipate) with respect to the total weight of said composition.

4. The composition according to claim 1, comprising from 0 to 5%, and preferably from 0.5 to 2% by weight of at least one vinyl polymer selected from the group formed from grafted or non-grafted polyvinyl acetate and non-grafted polyethylene vinyl acetate or grafted polyethylene vinyl acetate, preferably the vinyl polymer is polyvinyl acetate.

5. The composition according to claim 1, comprising from 0 to 10%, preferably from 0 to 5% of at least one additive chosen from plasticizers, slip agents, implementation aids, anti-blocking agents.

6. The composition according to claim 1, comprising:
from 60 to 65% by weight of PBS, and from 3 to 7% of PLA, as rigid polymers, relative to the total weight of the composition;
from 25 to 30% by weight of PBSA as flexible polymer, relative to the total weight of the composition;
from 0.5 to 2% by weight of behenamide relative to the total weight of the composition;
from 0.2 to 5%, and preferably from 0.5 to 2% by weight of polyvinyl acetate relative to the total weight.

7. The composition according to claim 1, prepared from (co)polyesters of which at least 50% by weight are biobased as defined by the ASTM D6866-22 standard.

8. A method for preparing a single-layer film from the composition according to claim 1, comprising a step of extrusion blowing.

9. A single-layer film comprising, preferably being constituted of, the composition according to claim 1, or prepared by a method for preparing a single-layer film from the composition, comprising a step of extrusion blowing, preferably with a thickness ranging from 35·10⁻⁶ m to 40·10⁻⁶ m.

10. The single-layer film according to claim 9, having the following properties: a water vapor permeability ranging from 70 to 180 in g/(m²·day), preferably less than 160 in g/(m²·day), and in an even more preferred manner less than 110 in g/(m²·day), the water vapor permeability being determined in accordance with the ASTM E96-22 standard, on films of 35·10⁻⁶ m thickness.

11. An article comprising, preferably being constituted of, the single-layer film according to claim 9.

12. The article according to claim 11, wherein the article is a wicket bag, preferably intended for packaging bakery products, in particular sandwich bread.
